(19) United States
(12) Patent Application Publication
(10) Pub. No.: US 2025/0343310 A1
(43) Pub. Date: Nov. 6, 2025

(54) Housing

(71) Applicant: DEUTZ Aktiengesellschaft, Cologne (DE)

(72) Inventor: Oliver Günther Hoffmann, Grafschaft (DE)

(21) Appl. No.: 19/195,885

(22) Filed: May 1, 2025

(30) Foreign Application Priority Data
May 2, 2024 (DE) 10 2024 112 322.2

(51) Int. Cl. H01M 50/258; H01M 50/209

(52) U.S. Cl. CPC H01M 50/258; H01M 50/209

(57) ABSTRACT

A housing including: a first housing element, which extends in the form of a prism along a longitudinal axis, where the housing element has a first side wall and a second side wall, between which a support section extends, which spans a first support plane (E_T2), and a second housing element, which is connected to the first housing element in such a way that a first housing chamber is bounded by the first housing element and the second housing element, where a supporting element for supporting the housing relative to an adjacent element can be connected to the first housing element via a first screw, and where the first screw engages in a threaded bore of the first housing element, the threaded bore is arranged at least partially in the first support plane and a bore axis of the threaded bore is arranged parallel to the first support plane.

### TECHNICAL FIELD

The present disclosure relates to a housing, in particular for an energy storage device.

### BACKGROUND

Housings for energy storage devices have the purpose of accommodating the energy storage device and protecting it from environmental influences. Furthermore, housings for energy storage devices can include interfaces for transferring electrical energy between individual batteries or to an electrical load.

DE 10 2022 000 414 A1 discloses a housing for an energy storage device comprising several prismatic housing elements stacked on top of one another. Cover elements are welded to the housing elements on the front faces of the housing, in which connections for a supporting element are formed.

### BRIEF SUMMARY

An aspect of the disclosure is to propose a housing that enables mounting relative to adjacent elements and has a high durability.

According to this aspect, a housing, in particular for an energy storage device, is proposed, comprising: a first housing element, which extends in the form of a prism with a base face along a longitudinal axis, wherein the housing element has a first side wall on a first longitudinal side and a second side wall on a second longitudinal side, between which a support section extends, which spans a first support plane, and a second housing element, which is spaced apart from the support section transversely to the longitudinal axis and is connected to the first housing element in such a way that a first housing chamber is bounded by the first housing element and the second housing element, wherein a supporting element for supporting the housing relative to an adjacent element can be connected to the first housing element via a first screw, and wherein the first screw engages in a threaded bore of the first housing element, the threaded bore is arranged at least partially in the first support plane and a bore axis of the threaded bore is arranged parallel to the first support plane.

The housing has the advantage that the bearing forces acting on the housing from the supporting element are directly supported by the support section. This eliminates the need for additional interfaces, such as weld seams, which are stressed by the bearing force. All in all, this increases the durability of the housing.

A prism is to be defined as a geometric body which is formed by parallel displacement or extrusion of a planar base face along an axis which extends transversely to the planar base face. A prism is produced, for example, by extrusion through a polygonal shaping opening. In this respect, the housing element can be produced by extrusion or extrusion molding. The housing element in the form of a prism within the meaning of the present disclosure should also be understood that the housing element has a prismatic basic shape which contains subsequently introduced machining operations, so that the housing element is prismatic at least partially. In this respect, the housing element can be produced by extrusion or extrusion molding and have subsequent machining operations.

The longitudinal side of a housing element should be understood as the sides of the housing element that are arranged parallel to the longitudinal axis. Accordingly, the front faces of the housing element are arranged transversely to the longitudinal axis and also to the longitudinal sides. Hence, the front faces can also be referred to as cross faces.

The support sections described in the application each span a support plane in such a way that the support plane passes through the geometric center of gravity of the cross-sectional area of the respective support section.

In a possible embodiment, the bore axis of the threaded bore of the first housing element can be arranged in the first support plane.

In a possible embodiment, the second housing element can be designed in the form of a prism that extends in a direction parallel to the longitudinal axis with a base face. The second housing element can have a first side wall on a first longitudinal side and a second side wall on a second longitudinal side, between which a support section extends, which spans a second support plane. The supporting element can be connected to the second housing element via a second screw. The second screw can engage in a threaded bore of the second housing element. A bore axis of the threaded bore can be arranged parallel to the second support plane. In particular, the bore axis of the threaded bore of the second housing element can be arranged in the second support plane. Alternatively or in combination, the threaded bore can be arranged at least partially in the second support plane.

In a further possible embodiment, a third housing element can be designed in the form of a prism that extends in a direction parallel to the longitudinal axis with a base face. The third housing element can have a first side wall on a first longitudinal side and a second side wall on a second longitudinal side, between which a support section extends, which spans a third support plane. The third housing element can be spaced transversely to the longitudinal axis from the support section of the second housing element and connected to the second housing element in such a way that a second housing chamber is bounded by the second housing element and the third housing element. The second housing element and the third housing element can have the same prismatic shape or the same base face of the prism. The third housing element can have a threaded bore. The threaded bore can be arranged at least partially in the third support plane. A bore axis of the threaded bore can be arranged parallel to the third support plane. In particular, the bore axis of the threaded bore of the third housing element can be arranged in the third support plane.

The threaded bore of the second housing element can be complementary to the first screw and to the second screw. The threaded bore of the third housing element can be complementary to the second screw.

In a possible embodiment, the first support plane, the second support plane and the third support plane can be aligned in parallel. The distance between the first support plane and the second support plane can be the same as the distance between the second support plane and the third support plane.

In a possible embodiment, the supporting element may have a connecting portion that is in abutment with the first side wall of the first housing element and/or with the first side wall of the second housing element. The connecting portion of the supporting element can have a first fitting portion and a second fitting portion. The first housing element can have a recess. The recess of the first housing element can be designed complementary to the first fitting portion. The second housing element can have a recess. The recess of the second housing element can be designed complementary to the first fitting portion and the second fitting portion. The third housing element can have a recess. The recess of the third housing element can be designed complementary to the second fitting portion.

In a possible embodiment, the supporting element can have a support section via which the supporting element can be brought into contact with the adjacent element. The support portion can extend transversely to the connecting portion.

In a possible embodiment, the first side wall of the first housing element may be in contact with the first side wall of the second housing element. The second side wall of the first housing element can be in contact with the second side wall of the second housing element.

In a possible embodiment, a first front face cover can be connected to the first housing element on a first front face of the housing. A second front face cover can be connected to the first housing element at a second front face of the housing. A third front face cover can be connected to the second housing element on the first front face of the housing. A fourth front face cover can be connected to the second housing element on the second front face of the housing. The first housing chamber can be bounded by the first housing element, the second housing element, the first front face cover, the second front face cover, the third front face cover and the fourth front face cover.

### BRIEF DESCRIPTION OF THE DRAWINGS

Embodiments of the housing are explained below with reference to the Figures. Herein

FIG. 1 is a perspective view of a housing for an energy storage device with the supporting elements in a first position,

FIG. 2 is a front view of the housing according to FIG. 1;

FIG. 3 is a cross-section of the housing from FIG. 1, showing only the base element and two intermediate elements;

FIG. 4 shows an enlarged view of detail IV from FIG. 3;

FIG. 5 shows an enlarged view of detail V from FIG. 1;

FIG. 6 a perspective view of the housing of FIG. 1 with the supporting elements in a second position, and

FIG. 7 is a front view of the housing according to FIG. 6.

### DETAILED DESCRIPTION

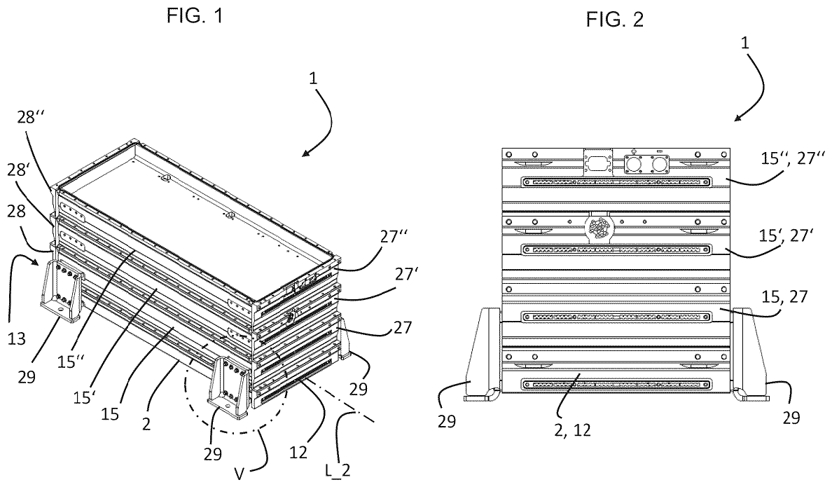

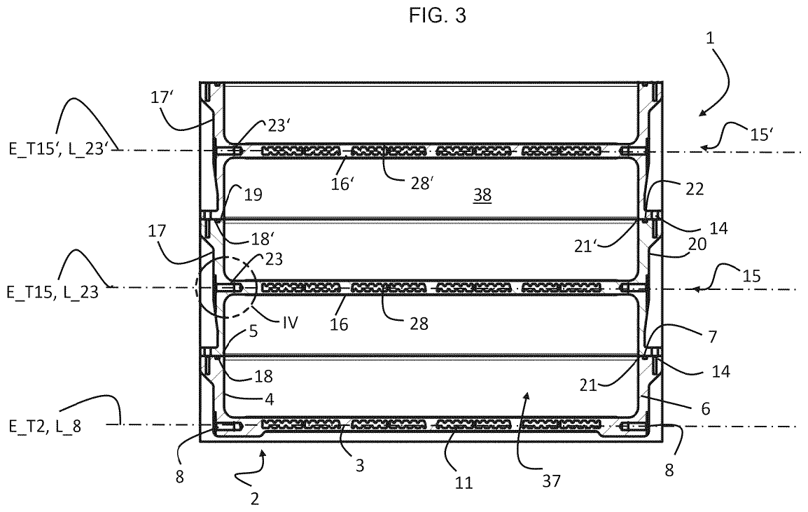

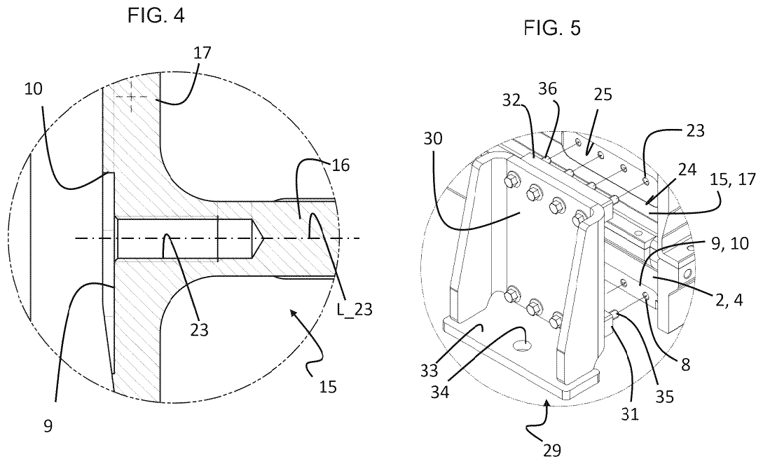

FIGS. 1 to 7, which are described together below, show a housing 1, in which a plurality of housing elements are stacked on top of one another in such a way that a plurality of housing chambers are defined by the housing elements.

The housing 1 comprises a first housing element in the form of a base element 2. The base element 2 has a prismatic basic shape and extends along the longitudinal axis L_2. A base face of the base element 2 is U-shaped, with a first side wall 4 on a first longitudinal side and a second side wall 6 on a second longitudinal side. The first side wall 4 has a flat mounting surface 5 at a first end, which can also be referred to as a connecting surface. The second side wall 6 has a flat mounting surface 7 at an end, which can also be referred to as a connecting surface. The mounting surfaces can also be referred to as flange surfaces. The base element 2 is made from a extruded raw part.

A flat support section 3 extends between the first side wall 4 and the second side wall 6. The support section 3 is connected to the respective side wall 4, 6 at the end facing away from the mounting surface 5, 7. The support section 3 describes a first support plane E_T2. Cooling channels 11 are formed in the support section 3, which extend in a direction parallel to the longitudinal axis L_2 and through which coolant can flow. A battery module can be placed on the support section 3. In other words, battery modules can be supported or carried by the support section 3.

The base element 2 comprises several threaded bores 8, each of which extend along a bore axis L_8 through the first side wall 4 into the support section 3. The bore axis L_8 is aligned parallel to the first support plane E_T2. In this case, the bore axis L_8 lies in the first support plane E_T2. The threaded bores 8 are designed as blind holes.

In the region of a first axial end of the first side wall 4, four of these threaded bores 8 are provided next to one another, as can be seen in particular from the combined view of FIGS. 1 and 5. These each extend through a support surface 9, which is formed by a recess 10 in the base element 2. The recess 10 is formed by machining the extruded raw part of the base element 2. In the area of the second axial end of the first side wall 4, the first axial end of the second side wall 6 and the second axial end of the second side wall 6, further groups of four threaded bores 8 are provided next to each other. These also extend through a support surface 9, which is formed by a recess 10.

The housing 1 further comprises a first front face cover 12, which is connected to the base element 2 at a first front face thereof, and a second front face cover 13, which is connected to the base element 2 at a second front face thereof. The first and second front face covers 12, 13 are each welded to the base element 2.

The housing 1 also comprises a second housing element in the form of an intermediate element 15. The intermediate element 15 has a prismatic basic shape and extends in a direction parallel to the longitudinal axis L_2. A base face of the intermediate element 15 is H-shaped, with a first side wall 17 on a first longitudinal side and a second side wall 20 on a second longitudinal side. The first side wall 17 has a flat lower mounting surface 18 at a first end, which can also be referred to as a connecting surface. The first side wall 17 has a flat upper mounting surface 19 at a second end, which can also be referred to as a connecting surface. The second side wall 20 has a flat lower mounting surface 21 at a first end, which can also be referred to as a connecting surface. The second side wall 20 has a flat upper mounting surface 22 at a second end, which can also be referred to as a connecting surface.

A flat support section 16 extends between the first side wall 17 and the second side wall 20. The support section 16 is connected between the lower mounting surfaces 18, 21 and the upper mounting surfaces 19, 22 of the respective side wall 4, 6. The support section 16 describes a second support plane E_T15. The support plane E_T15 is aligned parallel to the first support plane E_T2. Cooling channels 26 are formed in the support section 16, which extend in a direction parallel to the longitudinal axis L_2 and through which coolant can flow.

The intermediate element 15 comprises several threaded bores 23, each of which extend along a bore axis L_23 through the first side wall 17 into the support section 16. The bore axis L_23 is aligned parallel to the second support plane E_T15. In this case, the bore axis L_23 lies in the second support plane E_T15. The threaded bores 23 are designed as blind holes.

In the region of a first axial end of the first side wall 17, four of these threaded bores 23 are provided next to one another. These extend each through a support surface 24, which is formed by a recess 25. In the area of the second axial end of the first side wall 17, the first axial end of the second side wall 20 and the second axial end of the second side wall 20, further groups of four threaded bores 23 are provided next to each other. These also extend through a support surface 24, which is formed by a recess 25.

The housing 1 further comprises a third front face cover 27, which is connected to the base element 2 at the first front face thereof, and a fourth front face cover 28, which is connected to the base element 2 at the second front face thereof. The first and second front face covers 12, 13 are each welded to the base element 2.

The housing 1 also comprises a third housing element and a fourth housing element in the form of a second intermediate element 15′ and a third intermediate element 15″. The second intermediate element 15′ and the third intermediate element 15″ are each designed identically to the first intermediate element 15. In this respect, what has been said in the context of the intermediate element 15 also applies analogously to the second intermediate element 15′ and the third intermediate element 15″. In the Figures, identical features are provided with identical reference signs, whereby the features of the second intermediate element 15′ and the third intermediate element 15″ are additionally marked with one and two apostrophes respectively.

The mounting surface 5 of the base element 2 is in sealing contact with the lower mounting surface 18 of the intermediate element 15 and the mounting surface 7 is in sealing contact with the lower mounting surface 21 of the intermediate element 15. Several screws 14 extend through the aforementioned surfaces, so that the first side walls 4, 17 and the second side walls 6, 20 of the respective housing elements are clamped together in a sealing manner. The first front face cover 12 and the third front face cover 27 as well as the second front face cover 13 and the fourth front face cover 28 are clamped tightly by means of further screws. Thus, a first housing chamber 37 is delimited by the base element 2, the intermediate element 15 and the four front face covers 12, 13, 27, 28. A first energy storage device can be inserted in the first housing chamber 37.

The upper mounting surface 19 of the intermediate element 15 is in sealing contact with the lower mounting surface 18′ of the second intermediate element 15′ and the upper mounting surface 22 of the intermediate element 15 is in sealing contact with the lower mounting surface 21′ of the second intermediate element 15′. Several screws 14 extend through the aforementioned surfaces, so that the first side walls 17, 17′ and the second side walls 20, 20′ of the respective housing elements 15, 15′ are clamped together in a sealing manner. The third front face covers 27, 27′ and the fourth front face cover 28, 28′ are each clamped tightly by means of further screws. Thus, a second housing chamber 38 is delimited by the first intermediate element 15, the second intermediate element 15′ and the four front face covers 27, 27′, 28, 28′. A second energy storage device can be inserted in the second housing chamber 38.

As shown in FIGS. 1, 2, 6 and 7, the second intermediate element can be connected to one or more further intermediate elements, so that further housing chambers are formed into which further energy storage devices can be inserted. The series of intermediate elements can be terminated by an end element not shown, whereby the end element can be designed in the same way as the base element.

The housing 1 has at least one supporting element 29, via which the housing 1 can be mounted or supported relative to an adjacent element, for example relative to a frame or the floor. Here, the supporting element 29 can be brought into contact with the adjacent element via a supporting portion 33. The supporting portion 33 has a through hole 34 through which a screw can engage in a thread in the adjacent element. The adjacent element can be a floor panel or a vehicle, for example.

The supporting element 29 has a connecting portion 30 which, in the first position of the supporting element 29 shown in FIGS. 1 to 5, is in abutment with the first side wall 4 of the base element 2 and is in abutment with the first side wall 17 of the first intermediate element 15. For this purpose, a fitting portion 31 is seated in the complementary recess 10 of the base element 2 and a second fitting portion 32 is seated in the complementary recess 25 of the first intermediate element 15. Four screws 35 each extend through the connecting portion 30 with the fitting portion 31 and engage in the associated threaded bores 8 of the base element 2, so that the base element 2 and the supporting element 29 are braced together via the screws 35. Four screws 36 each extend through the connecting portion 30 with the fitting portion 32 and engage in the associated threaded bores 23 of the first intermediate element 15, so that the intermediate element 15 and the supporting element 29 are clamped together via the screws 36. It will be understood that the supporting element 29 shown and the associated connection to the housing 2 via eight screws is exemplary and, in particular, the supporting element can be connected to the housing 2 via more or fewer screws.

In the present case, the housing 1 has four supporting elements 29, which are connected to the base element 2 and the first intermediate element 15 at the respective corners in the first position. The four supporting portions of the four supporting elements together form a supporting plane. The supporting plane can be arranged vertically below the first support plane E_T2.

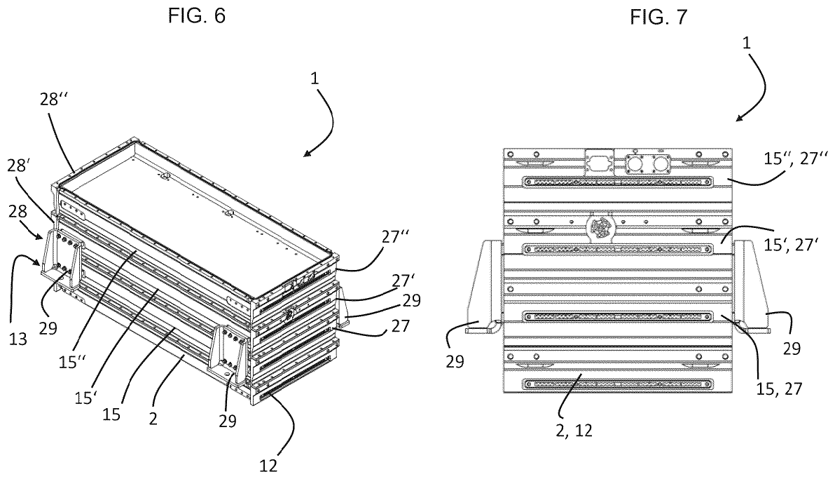

The supporting element can optionally be arranged in the second position shown in FIGS. 5 and 6. In this case, the connecting portion 30 can be in contact with the first side wall 17 of the first intermediate element 15 and in contact with the first side wall 17′ of the second intermediate element 15′. For this purpose, the fitting portion 31 is seated in the complementary recess 25 of the first intermediate element 15 and the second fitting portion 32 is seated in the complementary recess 25′ of the second intermediate element 15′. Four screws 35 each extend through the connecting portion 30 with the fitting portion 31 and engage in the associated threaded bores 23 of the first intermediate element 15, so that the intermediate element 15 and the supporting element 29 are clamped together via the screws 35. The four screws 36 each extend through the connecting portion 30 with the fitting portion 32 and engage in the associated threaded bores 23′ of the second intermediate element 15′, so that the second intermediate element 15′ and the supporting element 29 are clamped together via the screws 36.

In the second position, the four supporting elements are connected at their respective ends to the first intermediate element 15 and the second intermediate element 15′. The four supporting portions of the four supporting elements together form a supporting plane. The supporting plane can be arranged vertically above the first support plane E_T2.

It is understood that the supporting elements 29 may also be connected to the second intermediate element 15′ and the third intermediate element 15″ in a third position.

The Figures show an embodiment in which the supporting elements 29 are each supported in a first housing element and in a second housing element. For low loads in particular, it is also conceivable that the supporting elements are only supported in one housing element.

1. Housing, in particular for an energy storage device:
a first housing element, which extends in the form of a prism with a base face along a longitudinal axis,
wherein the housing element has a first side wall on a first longitudinal side and a second side wall on a second longitudinal side, between which a support section extends, which spans a first support plane, and
a second housing element, which is spaced apart from the support section transversely to the longitudinal axis and is connected to the first housing element in such a way that a first housing chamber is bounded by the first housing element and the second housing element,
wherein a supporting element for supporting the housing relative to an adjacent element can be connected to the first housing element via a first screw, and
wherein the first screw engages in a threaded bore of the first housing element, the threaded bore is arranged at least partially in the first support plane and a bore axis of the threaded bore is arranged parallel to the first support plane.

2. Housing according to claim 1, wherein
the second housing element is designed in the form of a prism which extends in a direction parallel to the longitudinal axis with a base face,
the second housing element has a first side wall on a first longitudinal side and a second side wall on a second longitudinal side, between
which a support section extends, which spans a second support plane,
the supporting element can be connected to the second housing element via a second screw, and
the first screw engages in a threaded bore of the second housing element, wherein the threaded bore is arranged at least partially in the second support plane and a bore axis of the threaded bore is arranged parallel to the second support plane.

3. Housing according to claim 1,
wherein
the third housing element is designed in the form of a prism which extends in a direction parallel to the longitudinal axis with a base face,
the third housing element has a first side wall on a first longitudinal side and a second side wall on a second longitudinal side, between which a support section extends, which spans a third support plane, and
the third housing element is spaced apart from the support section of the second housing element transversely to the longitudinal axis and is connected to the second housing element in such a way that a second housing chamber is bounded by the second housing element and the third housing element.

4. Housing according to claim 3, wherein
the second housing element and the third housing element have the same prismatic shape or the same base face of the prism.

5. Housing according to claim 3, wherein
the third housing element comprises a threaded bore, wherein the threaded bore is arranged at least partially in the third support plane and a bore axis of the threaded bore is arranged parallel to the third support plane.

6. Housing according to claim 5, wherein
the threaded bore of the second housing element is complementary to the first screw and to the second screw, and
wherein the threaded bore of the third housing element is complementary to the second screw.

7. Housing according to one of claim 3, wherein
the first support plane, the second support plane and the third support plane are aligned in parallel and
wherein the distance between the first support plane and the second support plane is equal to the distance between the second support plane and the third support plane.

8. Housing according to one of claim 2, wherein
the supporting element has a connecting portion which is in abutment with the first side wall of the first housing element and/or is in abutment with the first side wall of the second housing element.

9. Housing according to claim 8, wherein
the connecting portion of the supporting element has a first fitting portion and a second fitting portion,
the first housing element has a recess,
the second housing element has a recess,
the third housing element has a recess,
the recess of the first housing element is complementary to the first fitting portion,
the recess of the second housing element is complementary to the first fitting portion and to the second fitting portion, and
the recess of the third housing element is complementary to the second fitting portion.

10. Housing according to claim 8, wherein
the supporting element has a supporting portion via which the supporting element can be brought into contact with the adjacent element, and which extends transversely to the connecting portion.

11. Housing according to claim 1, wherein
the first side wall of the first housing element is in contact with the first side wall of the second housing element, and
wherein the second side wall of the first housing element is in contact with the second side wall of the second housing element.

12. Housing according to claim 1, wherein
a first front face cover is connected to the first housing element at a first front face of the housing, and
wherein a second front face cover is connected to the first housing element at a second front face of the housing.

13. Housing according to claim 11, wherein
a third front face cover is connected to the second housing element at the first front face of the housing,
a fourth front face cover is connected to the second housing element at the second front face of the housing, and
the first housing chamber is bounded by the first housing element, the second housing element, the first front face cover, the second front face cover, the third front face cover and the fourth front face cover.
